(19) United States
(12) Patent Application Publication
(10) Pub. No.: US 2023/0405633 A1
(43) Pub. Date: Dec. 21, 2023

(54) CONVEYING DEVICE AND FOLLOW-UP PLATE FOR CONVEYING A PASTY MASS

(71) Applicant: Glaston Germany GmbH, Neuhausen-Hamberg (DE)

(72) Inventor: Florian Gerl, Unterreichenbach (DE)

(73) Assignee: Glaston Germany GmbH, Neuhausen-Hamberg (DE)

(21) Appl. No.: 18/335,426

(22) Filed: Jun. 15, 2023

(30) Foreign Application Priority Data
Jun. 20, 2022 (DE) 10 2022 115 312.6

(51) Int. Cl. B05C 11/11; B05C 11/10

(52) U.S. Cl. CPC B05C 11/11; B05C 11/1042; C03C 27/10

(57) ABSTRACT

A conveying device for conveying a pasty mass in the manufacture of insulating glass includes a carrier for a cylindrical container with pasty mass. A follow-up plate is arranged above the carrier and is vertically displaceable for placing on the pasty mass. A conveyor line is connected to the follow-up plate for further transport of the pasty mass. The follow-up plate has an underside and at least an outlet opening arranged in the follow-up plate for connection with the conveyor line. On the underside several downwardly projecting projections are arranged around the outlet opening which are configured to be immersed in the pasty mass. At least one of the projections is formed as a rib extending radially outwards along the underside of the follow-up plate.

### CROSS-REFERENCE TO RELATED APPLICATIONS

This application claims priority to the German application number 10 2022 115 312.6 filed on Jun. 20, 2022, the entire content of which is fully incorporated herein with this reference.

### DESCRIPTION

### Field of the Invention

The invention relates to a conveying device for conveying a pasty mass in the manufacture of insulating glass and a follow-up plate intended therefor. The conveying device comprises a carrier for a cylindrical container containing pasty mass, a follow-up plate arranged above the carrier and being vertically displaceable for placing on the pasty mass, and a conveyor line connected to the follow-up plate for further transport of the pasty mass. The follow-up plate comprises an underside and at least one outlet opening. The at least one outlet opening is arranged in the follow-up plate and is configured to be connected to a conveyor line. Several downwardly projecting projections are arranged on the underside of the follow-up plate around the at least one outlet opening, wherein said projections are configured to be immersed in the pasty mass.

### Background of the Invention

Such a conveying device with such a follow-up plate is known from DE 689 05 676 T2 and/or EP 0347 269 B1. Said conveying device has a carrier for a cylindrical container with pasty mass, namely of butyl rubber-like organic material. Above the carrier, a vertically displaceable follow-up plate is arranged to be placed on the surface of the pasty mass. A conveyor line is connected to the follow-up plate for further transport of the pasty mass. The follow-up plate has an upper side, an underside and at least one outlet opening which is connected to the conveyor line. Several downwardly projecting projections are arranged on the underside of the follow-up plate. The projections are cylindrical and are arranged around the outlet opening. The projections are configured to be immersed in the pasty mass.

From EP 0 171 309 A1 a conveying device with a follow-up plate is known, on the underside of which several downwardly projecting projections are arranged which also have a cylindrical shape. The cylindrical projections have a height measured in a vertical section through the follow-up plate, which is greater at a location near the outlet opening than at a location further away from the outlet opening. The follow-up plate and/or the projections are heated.

From EP 0 943 583 A1 a conveying device with a heatable follow-up plate is known, on the underside of which several downwardly projecting projections are arranged. The projections are formed as tapered ribs which are concentrically arranged to each other around the outlet opening.

A device for injecting a strand of a pasty mass into the space between two glass plates of an insulating glass pane is known from DE 10 2007 051 610 A1 which also discloses a conveying device and a follow-up plate of the type mentioned above.

From DE 10 2004 030 654 A1 a non-generic conveying device for viscous material is known, which comprises a circular follow-up plate having a centrally arranged outlet opening. No downwardly projecting projections are arranged around the outlet opening on the underside of the follow-up plate. On the underside of the follow-up plate, the outlet opening comprises a funnel and a cover element which covers the funnel. The cover element has openings for the viscous material to pass. The cover element is formed as a grating comprising a central ring and arms extending in radial direction from the ring. The grating is screwed to the follow-up plate via the arms and is flush with the underside of the follow-up plate in order to keep the greatest possible amount of the material contained in the funnel when the follow-up plate is lifted.

From EP 0 340 493 B1 a container for pasty masses is known which consists of a cylindrical housing which is separated into two separate chambers by a separating wall being arranged in longitudinal direction. At the upper end of each chamber, an outlet opening is provided. In each chamber, a semicircular piston is arranged which is displaceable in direction to the outlet opening. The piston head is convex so that the surface contacting the pasty mass is curved in direction to the pasty mass. On the side of the piston head facing away from the pasty mass, reinforcement elements are arranged which do not come in contact with the pasty mass. The reinforcement elements are ribs of different heights which are arranged in such an angle to each other that the intersection points of imaginary axes extending the ribs lie outside of the semicircular piston.

From U.S. Pat. No. 4,090,640 A1 a conveying device for hot melt adhesives having a heatable follow-up plate is known, wherein an insulation is provided atop the follow-up plate.

### SUMMARY OF THE INVENTION

The invention is based on the object of improving a conveying device and a follow-up plate of the aforementioned type.

This object is achieved by a follow-up plate having the features specified in claim 1 and a conveying device having the features specified in claim 12. Advantageous further developments of the invention are the subject matter of the dependent patent claims.

A conveying device according to the invention contains a carrier for a container with a pasty mass, for example with a capacity of 10 liters to 500 liters, in particular 20 liters to 200 liters. In particular, the container is a cylindrical container, for example a barrel, particularly a standard barrel of 200 liters. However, depending on the type of insulating glass manufacturing system, barrels of 20 liters may also be used. The carrier can be designed as a carrier plate, for example. Above the carrier, a vertically displaceable follow-up plate is arranged to be placed on the surface of the pasty mass. A conveyor line for further transport of the pasty mass is connected to the follow-up plate. At least one outlet opening is arranged in the follow-up plate for connecting the follow-up plate to the conveyor line. A pump, for example a gear pump, can be provided in the conveyor line in a manner known per se for further transport of the pasty mass.

The conveying device is used in particular in insulating glass manufacture to provide a large quantity of a pasty mass, for example an adhesive mass or a hot-melt adhesive. It can be part of an installation for the manufacture of insulating glass panes which are assembled from two or more glass plates. The glass plates of an insulating glass pane are each held at a predetermined distance from one another by means of a spacer. The pasty mass can be conveyed via the conveyor line to an applicator device with which a strand of the pasty mass is formed. The strand can be applied on a glass plate in order to form a spacer between two glass plates, as is known, for example, from EP 0 823 318 A1. However, the conveying device according to the invention can also convey the pasty mass to a device for sealing insulating glass panes, as is known, for example, from DE 10 2007 051 610 A1. There, a strand of the pasty mass is injected into the space between two glass plates in order to form an insulating glass pane from the glass plates which are already held at a distance from each other. The pasty mass can be, for example, a butyl rubber, a polyisobutylene, an organic polysulphide or a polyurethane.

The follow-up plate according to the invention has an upper side and an underside. It may have a peripheral surface extending between its upper side and its underside. The follow-up plate may, for example, be circular, particularly if the containers containing the pasty mass are substantially circular cylindrical standard barrels. To seal the follow-up plate to the inside of a wall of the cylindrical container, a seal may be arranged on the peripheral surface of the follow-up plate in a manner known per se. A plurality of downwardly projecting projections are arranged on the underside of the follow-up plate. The downwardly projecting projections are arranged around the at least one outlet opening. At least one of the projections is formed as a rib extending along the underside of the follow-up plate. The rib extends radially outwardly with respect to the outlet opening. With projections formed in such way as radially extending ribs, the pasty mass can be very well guided from the outer area of the container and/or the outer area of the follow-up plate to the centrally arranged outlet opening. Further, the flow resistance for the pasty mass can be reduced, which flows along the underside of the follow-up plate past the ribs to the outlet opening.

After an open top container of pasty mass has been positioned on the carrier of the conveying device, the follow-up plate is moved downwards and its underside is placed on the surface of the pasty mass in the container. The follow-up plate is then moved further down so that the projections on the underside of the follow-up plate are immersed in the pasty mass. Due to the fact that the follow-up plate is pushed down further, the pasty mass is displaced past the projections to the outlet opening in the follow-up plate and from there into the conveyor line. The follow-up plate can be heatable. It can contain a heating device. A heating element, in particular an electrical heating element, can be arranged in the follow-up plate and/or the at least one rib. The ribs can accordingly be designed in the manner of “cooling ribs”, by means of which heat is introduced from the heating device into the pasty mass in order to improve its flowability. The follow-up plate with its downwardly projecting ribs can, in particular, be formed in one piece as a casting, in particular from a light metal alloy with good thermal conductivity.

With the follow-up plate according to the invention, the conveying capacity of the conveying device can be increased considerably. When removing pasty mass from a 200 liters barrel, the mass flow conveyed by the conveying device can be increased by up to 50%. The follow-up plate can have only one outlet opening which is arranged centrally in the follow-up plate. Nevertheless, the follow-up plate according to the invention enables a conveying capacity of the pasty mass of more than 1 kg per minute, in particular more than 1.3 kg per minute. This may particularly be advantageous for insulating glass manufacturing systems in which insulating glass panes are manufactured where the distance between the individual glass plates is increased in order to improve the insulating effect. In this case, a large mass flow of the pasty mass is required for forming a large spacer and/or for sealing.

In a further embodiment, the follow-up plate can have a plurality of ribs extending along the underside of the follow-up plate. Each of the ribs can extend radial to the at least one outlet opening. In particular, each of the projections on the underside of the follow-up plate can be formed as a rib. The rib, in particular each of the ribs, can have a width measured in circumferential direction around the outlet opening which is smaller at a location near the outlet opening than at a location further away from the outlet opening. The width can decrease, in particular, continuously, as the distance from the outlet opening decreases. Each of the ribs can taper towards the outlet opening. A reduction of the rib width towards the center of the follow-up plate facilitates the flow of the pasty mass towards the outlet opening located there.

Each of the ribs has a length measured radial to the outlet opening. The length of the ribs is measured in a view from below onto the follow-up plate. The length of one rib may differ from the length of an adjacent rib. One of the ribs has a smaller length and one of the ribs has a larger length. The rib of smaller length can have a greater distance to the outlet opening than the rib of greater length. This distance is measured radial to the outlet opening. The rib of greater length can, in particular, be arranged between two ribs of smaller length. This allows the number of ribs arranged around the outlet opening to be increased. The area on the underside of the follow-up plate, which comes into contact with the pasty mass, can be considerably increased, so that the heat input into the pasty mass can be increased. In relation to a plane reference area, which is enclosed by the wall of the container, the area of the underside provided with the ribs is larger than said reference area by a factor of 2 to 5, in particular, by a factor of 3 to 4.

In a further embodiment of the follow-up plate, a space, which is arranged between two ribs being adjacent to each other, can form a guide channel for the pasty mass. The guide channel formed by two adjacent ribs and/or the space arranged between two adjacent ribs extends from a location near the outlet opening along the underside of the follow-up plate in radial direction to a location of the follow-up plate further away from the outlet opening. In other words, the guide channel and/or the space extends radially inwards from an external area of the follow-up plate. The guide channel is, when viewed in flow direction of the pasty mass flowing along the underside of the follow-up plate towards the outlet opening, upwardly bordered by the underside of the follow-up plate and laterally bordered by the two ribs. The guide channel is downwardly open. The guide channel and/or the space has thus a form of a furrow arranged at the underside of the follow-up plate. Several guide channels can be formed around the outlet opening by means of a plurality of adjacent ribs. Each guide channel can run radially in relation to the outlet opening along the underside of the follow-up plate. This can further reduce the flow resistance for the pasty mass at the underside of the follow-up-plate.

The guide channel and/or the space arranged between two adjacent ribs may have a varying height. The height of the space is measured in vertical direction, in particular, in a vertical section through the follow-up plate. The height of the space can be greater at a location near the outlet opening than at a location further away from the outlet opening. In particular, the height may increase, particularly continuously, with decreasing distance from the outlet opening. The height can increase along a curve of varying curvature. In a vertical section through the follow-up plate, the underside of the follow-up plate in the area of the space may have a bell-shaped contour.

In a further embodiment, the guide channel and/or the space arranged between two adjacent ribs can have a varying width. The width of the space is measured in circumferential direction around the outlet opening, in particular in a view from below onto the follow-up plate. The width of the space near the outlet opening can be smaller than at a location further away from the outlet opening. The width of the space can decrease, in particular, continuously, with decreasing distance from the outlet opening. The space and/or the guide channel has a free cross-sectional area for the pasty mass. The cross-sectional area of the space is calculated as the product of its width and its height. The cross-sectional area of the space is larger at a location near the outlet opening than at a location further away from the outlet opening. The cross-sectional area of the space can increase, in particular, continuously, with decreasing distance from the outlet opening. This can ensure that the flow resistance for the pasty mass is not increased due to the decreasing width of the space towards the outlet opening in such a way that the conveying of a large mass flow would be impaired.

In an embodiment of the invention, the follow-up plate can comprise several, in particular, two, outlet openings. In such a case, a separating rib can be arranged on the underside of the follow-up plate, which extends along the underside of the follow-up plate between two of the outlet openings and/or between the two outlet openings. The separating rib does not extend in radial direction in relation to the outlet openings, but transversely thereto. In the case of several outlet openings in the follow-up plate, the aforementioned characteristics of the ribs have to be related in each case to that of the outlet openings towards which the corresponding rib and/or the corresponding space extends radially.

In a further embodiment, the underside of the ribs, in particular all ribs, can lie in a horizontal plane. The underside of the ribs can extend perpendicular to the wall of the container with the pasty mass. The height of the ribs then corresponds to the height of the spaces. Thermal insulation may be arranged on the upper side of the follow-up plate. This can reduce heat losses of the heating device of the follow-up plate.

The conveying device may further comprise a support jacket for the container with the pasty mass. The support jacket is configured for being mounted externally along the periphery of the container. At least a circumferential section of the support jacket is formed of a mesh, in particular a woven fabric, of wire or fiber-reinforced plastic filaments. Due to its stability, such a support jacket is well suited to support the container with the pasty mass in a conveying device according to the invention when the follow-up plate is pressed downwards into the container with high pressure in order to convey large mass flows out of the container. At the same time, such a support jacket has a relatively low own weight. It can therefore be handled by one system operator without too much effort when changing the container with pasty mass.

### BRIEF DESCRIPTION OF THE DRAWINGS

Further details and advantages of the invention are explained by embodiments of the invention with reference to the accompanying drawings, and identical and equivalent components are provided therein with the same reference numerals. In such drawings:

FIG. 1 shows a perspective view on a simplified conveying device according to the present invention;

FIG. 2 shows a perspective view on the underside of a first embodiment of a follow-up plate according to the invention;

FIG. 3 shows a view from below on the follow-up plate of FIG. 2;

FIG. 4 shows a vertical section through the follow-up plate along the section IV-IV of FIG. 3;

FIG. 5 shows a diagonal view on the vertical section of FIG. 4;

FIG. 6 shows a view from below on a second embodiment of a follow-up plate according to the invention;

FIG. 7 shows a view from below on a third embodiment of a follow-up plate according to the invention;

FIG. 8 shows a view from below on a fourth embodiment of a follow-up plate according to the invention;

FIG. 9 shows a diagonal view similar to FIG. 5 on a vertical section through the follow-up plate of FIG. 8;

FIG. 10 shows a diagonal view from below on the follow-up plate of FIG. 8;

FIG. 11 shows a schematic diagonal view of a support jacket for the conveying device of FIG. 1;

FIG. 12 shows a view from below on a fifth embodiment of a follow-up plate according to the invention;

FIG. 13 shows a vertical section through the follow-up plate along the section XIII-XIII of FIG. 12.

### DETAILED DESCRIPTION OF EMBODIMENTS OF THE INVENTION

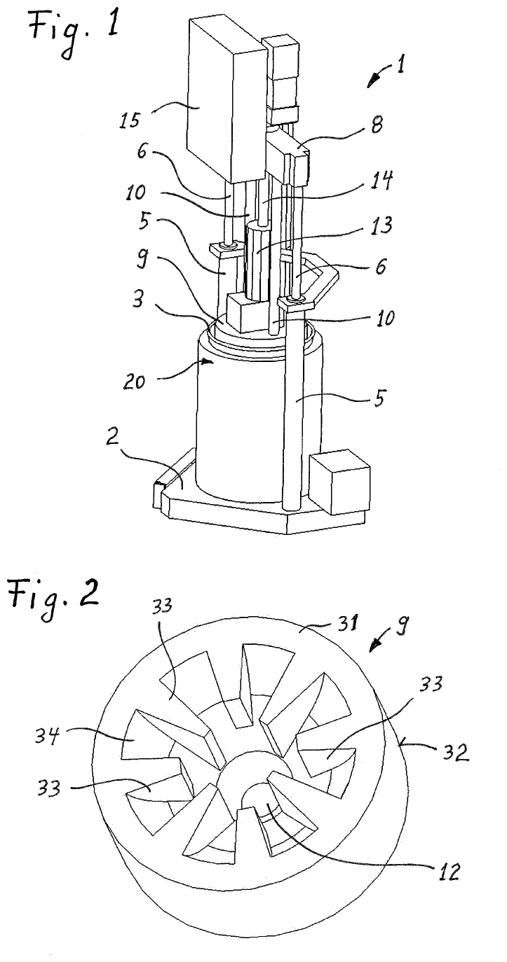

FIG. 1 shows a conveying device 1 according to the invention. It contains a carrier 2 for a cylindrical container 3 with pasty mass 4. The carrier 2 is designed as a carrier plate on which the container 3, which is open at the top, is placed. Two hydraulic cylinders 5 are attached to the carrier 2. The cylinders 5 each have a piston rod 6 which are connected to each other via a central crossbeam 8. A follow-up plate 9 is attached to the bottom of the crossbeam 8 via two vertical rods 10. By retracting the piston rods 6 into the hydraulic cylinders 5, the follow-up plate 9 is placed on the pasty mass 4 located in the container 3, see FIG. 4. By further retracting the piston rods 6, the pasty mass 4 is pressed through an outlet opening 12 in the follow-up plate 9 into a conveyor line 14 and/or into a pump 13 which is located above the follow-up plate 9 and conveys the pasty mass 4 further. The conveying device 1 is part of a system for manufacturing insulating glass not shown. The conveyor line 14 conveys the pasty mass 4 further to an applicator device in a manner known per se, as is known for example from EP 0 171 309 A1 or DE 10 2007 051 610 A1. The conveying device 1 has a control device 15 by means of which the cylinders 5 and the pump 13 can be controlled. A support jacket 20 is arranged around the container 3. The support jacket 20, see also FIG. 11, stabilizes the container 3 when the follow-up plate 9 is pulled into the container 3 by the cylinders 5. A circumferential section of the support jacket 20 is formed from a wire fabric 21. The wire fabric 21 can, for example, comprise wires having a diameter of from 0.4 mm to 2.0 mm, in particular, from 0.5 mm to 1.0 mm. The wires extending in the circumferential direction of the support jacket 20 are thinner than the wires of the wire fabric 21 extending in the longitudinal direction of the support jacket. This allows the wire fabric to fit very snugly against the outer circumference of the container 3. The wire fabric 21 is attached to bars 22, to which three quick-release fasteners 23 are attached. In order to place the support jacket 20 on a container 3, the quick-release fasteners 23 are first opened. Then, due to the flexibility of the wire fabric 21, the two strips 22 can be moved slightly away from each other so that the diameter of the support jacket 20 increases. The support jacket 20 is placed around a new, full container 3. Subsequently the quick-release fasteners 23 are closed again. This reduces the circumference of the support jacket 20 and the support jacket 20 tightens around the outer circumference of the container 3, stabilizing it. Due to the flexibility of the wire fabric 21 and its light weight, the support jacket 20 can be handled very easily by one system operator alone.

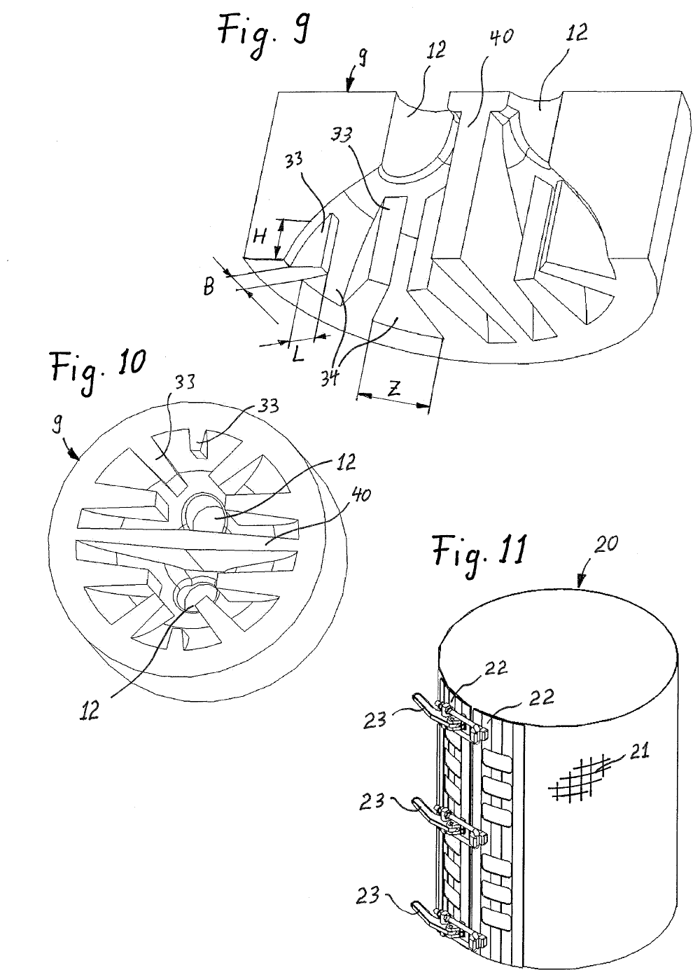

The embodiments of the follow-up plate 9 shown in FIGS. 2 to 10 and 12 to 13 each have an upper side 30, an underside 31 and a circumferential surface 32 extending between the upper side 30 and the underside 31. A seal can be arranged on the circumferential surface 32 in a manner not shown but known per se, which seals the follow-up plate 9 to the wall of the container 3. The follow-up plate 9 has several downwardly projecting projections in the form of ribs 33 on its underside 31. The ribs 33 are arranged around the outlet opening 12 and are configured to be immersed in the pasty mass 4. When the piston rods 6 are retracted, the ribs 33 are pressed into the pasty mass 4 from above. The ribs 33 immerse in the pasty mass 4. The pasty mass 4 flows along the underside 31 past the ribs 33 and is pressed out of the container 3 through the outlet opening 12. The follow-up plate 9 contains a heating device 36 with several electrical heating elements 37, see FIG. 4. A heating element 37 is arranged in one of the ribs 33. A thermal insulation 38 is arranged on the upper side 30 of the follow-up plate 9. In an embodiment not shown, a thermal insulation can be arranged around the wire mesh 21 of the support jacket 20. The heat loss can be reduced by the thermal insulation 38. Unwanted cooling of a preheated container 3 and/or losses of the heat introduced by the heating device 36 can thus be reduced.

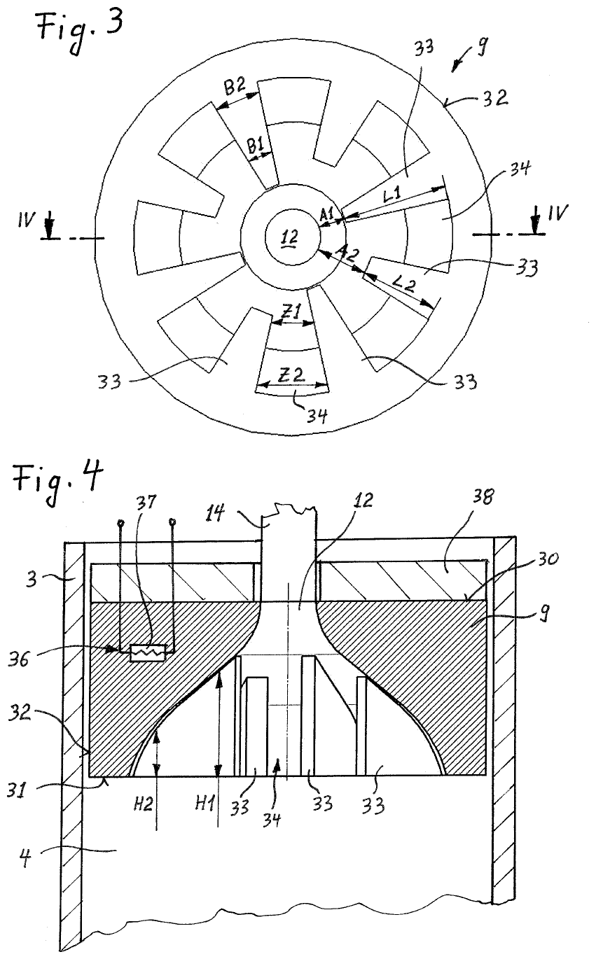

The ribs 33 have a width B measured in circumferential direction around the outlet opening 12 and a length L measured radially to the outlet opening 12, see FIGS. 3, 9 and 12. A width B1 near the outlet opening 12 is smaller than a width B2 at a location further away from the outlet opening 12, see FIG. 3. In FIGS. 3 and 9, it can also be seen that a length L1 of a rib 33 is different from the length L2 of an adjacent rib 33. The rib 33 of greater length L1 has a distance A1 measured radially to the outlet opening 12. The rib 33 of smaller length L2 has a distance A2 to the outlet opening 12. The distance A2 is greater than the distance A1. The rib 33 of greater length L1 is arranged between two ribs 33 of smaller length L2. This allows the area on the underside 31, which comes into contact with the pasty mass 4, to be considerably increased. The enlarged area is compared with a reference area. The size of a plane area enclosed by the wall of the container 3 is used as reference area. For a standard barrel with a capacity of 200 l, which has a diameter of 570 mm, the reference area is 0.26 m². The area on the underside 31, which comes into contact with the pasty mass 4, is larger than the reference area by a factor of 3 to 4. In this example, it can be 0.8 m² to 1.0 m².

Between each two adjacent ribs 33 there is a guide channel and/or space 34. The space 34 has a height H measured in the vertical direction, see vertical sections according to FIGS. 4, 9 and 13, and a width Z measured in the circumferential direction around the outlet opening 33, see FIGS. 3, 9 and 12. The height H1 of the space 34 at a location near the outlet opening 12 is greater than a height H2 of the space 34 at a location further away from the outlet opening 12. The height H increases continuously with decreasing distance from the outlet opening 12 along a curve with varying curvature. Thus, the underside of the follow-up plate 9 has a bell-shaped contour in the space 34, see FIGS. 4, 5 and 9. The height H of the spaces 34 at a location, which has the distance A from the outlet opening 12, corresponds to the height of the ribs 33 at a location having the same distance from the outlet opening 12. At a location near the outlet opening 12, the space 34 has a width Z1 which is smaller than a width Z2 at a location further away from the outlet opening 12, see FIGS. 3, 9 and 12. As the distance A from the outlet opening 12 decreases, the width Z decreases continuously along the ribs 33. A free cross-sectional area Z*H of the space 34, which is calculated as the product of the width Z and the height H, is larger at a location near the outlet opening 12 than at a location further away from the outlet opening 12. As the distance from the outlet opening 12 decreases, the cross-sectional area Z*H increases continuously along the ribs 33.

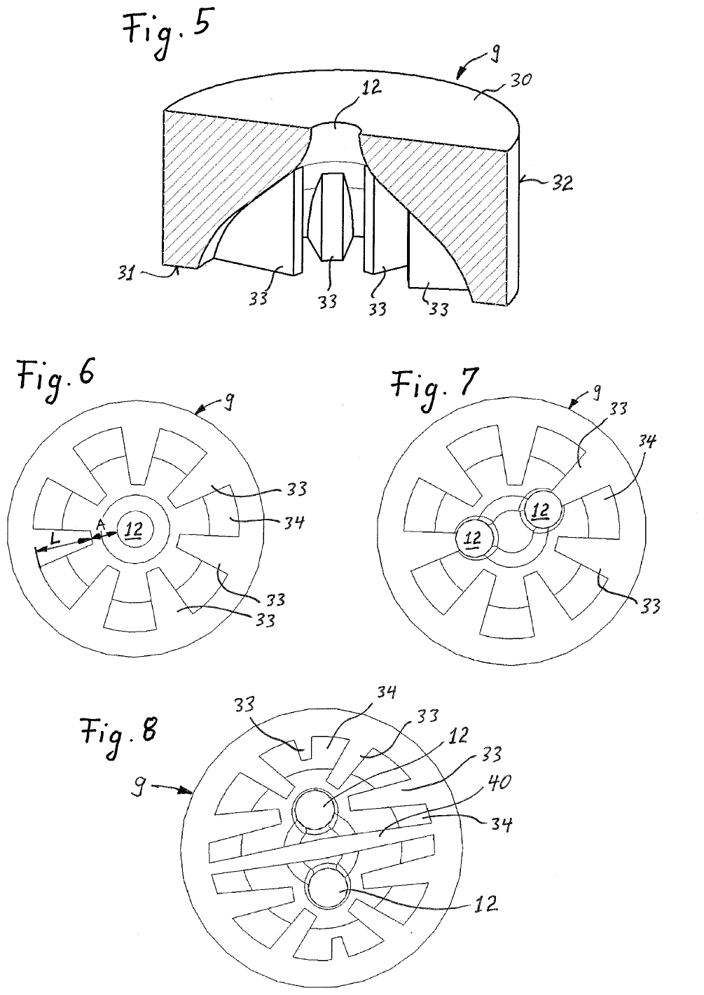

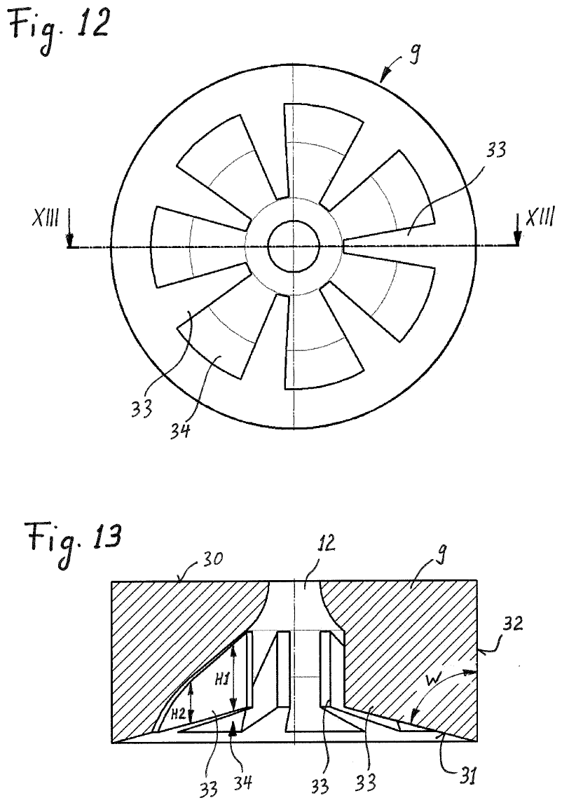

Instead of eight ribs 33 in FIG. 3, only seven ribs 33 are provided in the embodiment of the follow-up plate 9 shown in FIG. 6, all of which have the same length L and the same distance A from the outlet opening 12. The embodiments of the follow-up plate 9 shown in FIGS. 7 to 10 each have two outlet openings 12. In the embodiment shown in FIGS. 8 to 10, a separating rib 40 extends between the two outlet openings 12. The separating rib 40 extends transversely to a radial direction in relation to the outlet openings 12. The other ribs 33 extend radially outwards from the respective outlet opening 12. The ribs 33 have different lengths L and distances A. In the embodiments of FIGS. 12 and 13, it can be seen that the underside 31 of the follow-up plate 9 and/or the underside of the ribs 33 is oriented at an angle W to the circumferential surface 32 and/or the wall of the container 3 which is less than 90°. The angle W can be in the range between 80° and 87°.

### LIST OF REFERENCE NUMERALS

1 conveying device
2 carrier
3 container
4 pasty mass
5 cylinder
6 piston rod
8 crossbeam
9 follow-up plate
10 rod
12 outlet opening
13 pump
14 conveyor line
15 control device
20 support jacket
21 wire fabric
22 bar
23 quick-release fastener
30 upper side
31 underside
32 circumferential surface
33 rib
34 space
36 heating device
37 heating element
38 heat insulation
40 separating rib
A, A1, A2 distance
B, B1, B2 rib width
H, H1, H2 height
L, L1, L2 length
Z, Z1, Z2 space width
W angle

What is claimed is:

1. A follow-up plate configured for placing on a pasty mass in a conveying device for conveying the pasty mass in the manufacture of insulating glass, the follow-up plate comprising:
an underside and at least one outlet opening;
wherein the at least one outlet opening is arranged in the follow-up plate and is configured to be connected to a conveyor line;
wherein several downwardly projecting projections are arranged on the underside of the follow-up plate around the at least one outlet opening;
wherein said projections are configured to be immersed in the pasty mass; and
wherein at least one of the projections is formed as a rib extending radially outwards in relation to the outlet opening along the underside of the follow-up plate.

2. The follow-up plate according to claim 1, wherein the follow-up plate comprises several outlet openings.

3. The follow-up plate according to claim 1, wherein only one outlet opening is arranged centrally in the follow-up plate.

4. The follow-up plate according to claim 1, wherein a heating element is arranged in the rib.

5. The follow-up plate according to claim 1, wherein the rib has a width (B, B1, B2) measured in circumferential direction around the outlet opening which is smaller at a location (B1) near the outlet opening than at a location (B2) further away from the outlet opening.

6. The follow-up plate according to claim 1, which comprises several ribs each with a length (L, L1, L2) measured radial to the outlet opening, wherein one of the ribs has a smaller length (L2) and one of the ribs has a larger length (L1).

7. The follow-up plate according to claim 6, wherein the rib of smaller length (L2) has a greater distance (A2) to the outlet opening than the rib of greater length (L1).

8. The follow-up plate according to claim 6, wherein a rib of greater length (L1) is arranged between two ribs of smaller length (L2).

9. The follow-up plate according to claim 1, which comprises two adjacent ribs and a space arranged between the two adjacent ribs, wherein the space has a height (H, H1, H2) measured in vertical direction, which is greater at a location (H1) near the outlet opening than at a location further away from the outlet opening.

10. The follow-up plate according to claim 1, which comprises two adjacent ribs and a space arranged between the two adjacent ribs, wherein the space arranged between two adjacent ribs has a width (Z, Z1, Z2) measured in circumferential direction around the outlet opening which is smaller at a location (Z1) near the outlet opening than at a location (Z2) further away from the outlet opening.

11. The follow-up plate according to claim 1, which comprises two adjacent ribs and a space arranged between the two adjacent ribs, wherein the space has a height (H, H1, H2) measured in vertical direction, which is greater at a location (H1) near the outlet opening than at a location further away from the outlet opening, wherein the space arranged between two adjacent ribs has a width (Z, Z1, Z2) measured in circumferential direction around the outlet opening which is smaller at a location (Z1) near the outlet opening than at a location (Z2) further away from the outlet opening, and
wherein a cross-sectional area (Z*H) of the space, which is formed as a product from its width (Z) and its height (H), is larger at a location near the outlet opening than at a location further away from the outlet opening.

12. The conveying device for conveying the pasty mass in the manufacture of insulating glass comprising a carrier for a cylindrical container containing pasty mass, the follow-up plate arranged above the carrier and being vertically displaceable for placing on the pasty mass, and the conveyor line connected to the follow-up plate for further transport of the pasty mass, wherein the follow-up plate is formed according to claim 1.

13. The conveying device according to claim 12, wherein a heat insulation is arranged on the upper side of the follow-up plate.

14. The conveying device according to claim 12, which comprises a support jacket configured to be mounted externally on the cylindrical container, wherein at least a circumferential section of the support jacket is formed of a mesh.

15. The conveying device according to claim 14, wherein the mesh is a woven fabric.
